(19) United States
(12) Patent Application Publication
(10) Pub. No.: US 2025/0361807 A1
(43) Pub. Date: Nov. 27, 2025

(54) WEAR INDICATOR

(71) Applicant: Joy Global Underground Mining LLC, Warrendale, PA (US)

(72) Inventor: Paul Hogan, Ashtonfield, New South Wales (AU)

(21) Appl. No.: 18/875,048

(22) PCT Filed: Jun. 14, 2023
(86) PCT No.: PCT/US2023/068434

§ 371 Date: Dec. 13, 2024

Related U.S. Application Data
(60) Provisional application No. 63/352,124, filed on Jun. 14, 2022.
(60) Provisional application No. 63/425,595, filed on Nov. 15, 2022.

(51) Int. Cl. E21F 17/18; B32B 7/022; B32B 7/12; B32B 15/01; B32B 15/20; B65G 11/02; E02F 9/26; E21F 13/02; G01D 7/00

(52) U.S. Cl. CPC E21F 17/18; B32B 7/022; B32B 7/12; B32B 15/015; B32B 15/20; B65G 11/026; E21F 13/025; G01D 7/005; B32B 2307/7376; B32B 2311/12; B32B 2311/30; B65G 2207/48; E02F 9/267

(57) ABSTRACT

A wear indicator is supported on a wear surface of a machine component. The wear indicator includes a first material thickness indicator having a first thickness, a second material thickness indicator positioned adjacent the first material thickness indicator and having a second thickness that is less than the first thickness, and a third material thickness indicator positioned adjacent the first material thickness indicator and the second material thickness indicator and having a third thickness that is less than the second thickness. The wear indicator is configured to visually indicate a material thickness of the wear deck via the first, second, and third material thickness indicators.

### CROSS REFERENCE TO RELATED APPLICATIONS

The present application claims priority to U.S. Provisional Patent Application No. 63/352,124, filed on Jun. 14, 2022, and to U.S. Provisional Patent Application No. 63/425,595, filed Nov. 15, 2022. The entire contents of each of these applications are hereby incorporated by reference.

### TECHNICAL FIELD

The present disclosure relates to a wear indicator for mining machines and components.

Mining machines including, for example, haulage vehicles, conveyor systems, entry development and continuous mining machines, longwall mining systems, etc., experience wear over time. Operators and technicians may inspect and monitor components periodically to determine the condition and remaining working life of the components.

### SUMMARY

Some methods for inspecting components pose challenges due to inspector access, measurement accuracy, measurement consistency, in particular location consistency, and inspector awareness, among other things.

In one independent aspect, a wear indicator is supported on a wear surface of a machine component. The wear indicator includes a first material thickness indicator having a first thickness, a second material thickness indicator positioned adjacent the first material thickness indicator and having a second thickness that is less than the first thickness, and a third material thickness indicator positioned adjacent the first material thickness indicator and the second material thickness indicator and having a third thickness that is less than the second thickness. The wear indicator is configured to visually indicate a material thickness of the wear deck via the first, second, and third material thickness indicators.

In some aspects, the first material thickness indicator is disposed within an indicator housing, the second material thickness indicator is disposed within the indicator housing, and the third material thickness indicator is disposed within the indicator housing.

In some aspects, the indicator housing includes an upper surface configured to be positioned flush with the wear surface, and wherein, prior to experiencing wear, the first material thickness indicator is covered by the upper surface.

In some aspects, the indicator housing includes a bottom surface opposite the upper surface, the bottom surface including a plurality of blind bores configured to receive the first, second, and third material thickness indicators therein.

In some aspects, the first, second, and third material thickness indicators are positioned such that the first thickness, the second thickness, and the third thickness are measured parallel to a direction of wear of the wear surface.

In some aspects, the first thickness corresponds to 75% of a thickness of the wear indicator, such that the first material thickness indicator is configured to visually indicate 25% wear of the wear surface.

In some aspects, the second thickness corresponds to 50% of the thickness of the wear indicator, such that the second material thickness indicator is configured to visually indicate 50% wear of the wear surface.

In some aspects, the third thickness corresponds to 25% of the thickness of the wear indicator, such that the third material thickness indicator is configured to visually indicate 75% wear of the wear surface.

In some aspects, the first, second, and third material thickness indicators are formed from a material with a different color than that of the wear surface.

In some aspects, the first material thickness indicator has a first cross-sectional area as viewed along a wear direction, the second material thickness indicator has a second cross-sectional area as viewed along the wear direction, and the third material thickness indicator has a third cross-sectional area as viewed along the wear direction, and wherein the first cross-sectional area is less than the second cross-sectional area and the third cross-sectional area.

In some aspects, the second cross-sectional area is less than the third cross-sectional area.

In some aspects, the first, second, and third material thickness indicators are cylindrical.

In some aspects, the indicator housing is circular in profile when viewed parallel to a wear direction of the wear indicator.

In some aspects, the indicator housing includes an upper surface configured to be positioned flush with the wear surface, and wherein the upper surface and the wear surface are curved.

In another independent aspect, a mining machine includes a chassis, a wear deck supported by the chassis, the wear deck configured to support a material being mined, a mechanism for moving the material across the wear deck, and a plurality of wear indicators supported adjacent a surface of the wear deck. The plurality of wear indicators configured to provide a visual indication of a thickness of the wear deck.

In some aspects, each of the plurality of wear indicators includes a plurality of material thickness indicators configured to visually indicate 25%, 50%, and 75% wear.

In some aspects, the plurality of material thickness indicators are formed of a material having a different color than a material of the wear deck.

In some aspects, each of the plurality of material thickness indicators is disposed within an indicator housing, and wherein the indicator housing and the wear deck are formed of the same material.

In some aspects, an upper surface of the indicator housing is configured to be flush with the surface of the wear deck such that the indicator housing and the wear deck wear at the same rate.

In some aspects, the wear indicators are disposed on the wear deck.

In some aspects, the wear indicators are disposed under the surface of the wear deck.

In some aspects, the wear indicators are positioned within a housing.

In some aspects, the wear indicators are positioned within a housing disposed under the surface of the wear deck.

In yet another independent aspect, a wear indicator for a machine includes an indicator housing, a first material thickness indicator disposed within the indicator housing, the first annular material thickness indicator having a first thickness, a second annular material thickness indicator disposed within the indicator housing and surrounding the first annular material thickness indicator, the second annular material thickness indicator having a second thickness that is less than the first thickness, and a third annular material thickness indicator disposed within the indicator housing and surrounding the second annular material thickness indicator, the third annular material thickness indicator having a third thickness that is less than the second thickness. The wear indicator is configured to visually indicate a material thickness via the first, second, and third annular material thickness indicators.

In some aspects, the first annular material thickness indicator and the third annular material thickness indicator are a first color, and wherein the second annular material thickness material is formed of a second color that is different than the first color.

In some aspects, the first annular material thickness indicator is configured to be exposed from the indicator housing when the indicator housing has experienced 25% wear.

In some aspects, the second annular material thickness indicator is configured to be exposed from the indicator housing when the indicator housing has experienced 50% wear, such that both the first and second annular material thickness indicators are exposed after 50% wear.

In some aspects, the third annular material thickness indicator is configured to be exposed from the indicator housing when the indicator housing has experienced 75% wear, such that the first, second, and third annular material thickness indicators are exposed after 75% wear.

In some aspects, the first material thickness indicator is formed of brass.

In some aspects, the third annular material thickness indicator is formed of brass.

In some aspects, the second annular material thickness indicator is formed of steel.

In still another independent aspect, a wear indicator system is supported on a machine component. The wear indicator system includes a plurality of wear indicators positioned within proximity to each other on a machine component, the wear indicators secured within bores of the machine component formed on a surface opposite a wear surface of the machine component. The plurality of wear indicators includes a first wear indicator being spaced apart from the wear surface by a first distance, visible exposure of the first wear indicator indicating that the wear surface has completed a first stage of wear, a second wear indicator being spaced apart from the wear surface by a second distance greater than the first distance, visible exposure of the second wear indicator indicating that the wear surface has completed a second stage of wear, and a third wear indicator being spaced apart from the wear surface by a third distance greater than the second distance, visible exposure of the third wear indicator indicating that the wear surface has completed a third stage of wear.

In some aspects, the first wear indicator, the second wear indicator, and the third wear indicator are spaced apart from one another by between approximately 0 cm and approximately 5 cm.

In some aspects, the wear indicators are grouped within an indication area having a width of approximately 20 cm.

In some aspects, the bores include a plurality of blind holes, wherein each of the wear indicators is positioned within an associated one of a plurality of blind holes, each blind hole having a different depth that corresponds to a height of the respective wear indicator positioned within the blind hole.

In some aspects, the first stage of wear is approximately 25% of the acceptable wear.

In some aspects, the second stage of wear is approximately 50% of the acceptable wear.

In some aspects, the third stage of wear is approximately 75% of the acceptable wear.

In some aspects, the wear indicators are secured to the component via an interference fit.

In some aspects, the wear indicators are secured to the component via an adhesive.

In some aspects, each of the wear indicators has the same cross-sectional dimension as the others.

In some aspects, the system further comprises a plurality of groups of wear indicators, each group positioned the machine component at different locations and configured to detect wear at different locations on the machine component.

In some aspects, wear experienced by the machine component is mapped and tracked by consistently measuring wear at each location as the wear indicators are revealed at each location.

In some aspects, data from wear measurements is collected and stored by a processing system and a computer storage system.

In some aspects, a camera system includes at least one camera for monitoring the component and the wear indicators to capture the data from the wear indicators.

In some aspects, visible exposure of one indicator of one of the groups indicates 25% wear at that location, visible exposure of two indicators of the one group indicates 50% wear at that location, and visible exposure of three indicators of the one group indicates 75% wear at that location.

Other features and aspects will become apparent by consideration of the following detailed description and accompanying drawings.

### BRIEF DESCRIPTION OF THE DRAWINGS

FIG. 1 is a side view of a haulage machine according to one embodiment.

FIG. 2 is a plan view of the haulage machine of FIG. 1.

FIG. 3 is an exploded perspective view of a wear indicator according to one embodiment.

FIG. 4 is a bottom view of the wear indicator of FIG. 3.

FIG. 5A is a cross-sectional view of the wear indicator of FIG. 4, viewed along section 5-5.

FIG. 5B is a cross-sectional view of a wear indicator according to another embodiment, viewed along section 5-5.

FIG. 6 is an exploded bottom perspective view of a wear indicator according to another embodiment.

FIG. 7 is a bottom view of the wear indicator of FIG. 6.

FIG. 8 is a cross-sectional view of the wear indicator of FIG. 7, viewed along section 8-8.

FIG. 9 is a side view of a wear indicator according to yet another embodiment.

FIG. 10 is a side view of a wear indicator according to yet another embodiment.

FIG. 11 is a side view of a wear indicator according to yet another embodiment.

FIG. 12 is a side view of a wear indicator according to yet another embodiment.

FIG. 13 is a plan view of a haulage machine according to another embodiment.

FIG. 14 is a plan view of a haulage machine including wear indicators according to another embodiment.

FIG. 15 is a plan view of a haulage machine including wear indicators according to yet another embodiment.

FIG. 16 is a plan view of a haulage machine including wear indicators according to still another embodiment.

FIG. 17 is a plan view of a material handling device for an entry development machine including wear indicators.

FIG. 18 is a plan view of a material handling device for an entry development machine including wear indicators according to another embodiment.

FIG. 19 is a plan view of a material handling device for an entry development machine including wear indicators according to yet another embodiment.

FIG. 20 is a plan view of a material handling device for an entry development machine including wear indicators according to still another embodiment.

FIG. 21 is a plan view of a material handling device for an entry development machine including wear indicators according to yet another embodiment.

FIG. 22 is a perspective view of a conveyor for an entry development machine including wear indicators.

FIG. 23 is a perspective view of a conveyor for an entry development machine including wear indicators according to another embodiment.

FIG. 24 is a perspective view of a flexible conveyor machine including wear indicators.

FIG. 25 is a plan view of the flexible conveyor machine of FIG. 24.

FIG. 26 is a section view of the flexible conveyor machine of FIG. 24, viewed along section 26-26.

FIG. 27 is a section view of the flexible conveyor machine of FIG. 24, viewed along section 27-27.

FIG. 28 is an elevation view of a dozer including a blade having wear indicators.

FIG. 29 is a perspective view of a portion of the dozer of FIG. 28.

FIG. 30 is another perspective view of a portion of the dozer of FIG. 28.

FIG. 31 is a plan view and a side view of an articulated truck including a bed having wear indicators.

FIG. 32 is a perspective view of the articulated truck of FIG. 31 with the bed in an elevated position.

FIG. 33 is a perspective view of a truck including a bed having wear indicators.

FIG. 34 is a plan view of the truck of FIG. 33.

FIG. 35 is a perspective view of a longwall mining system.

FIG. 36 is a plan view of the longwall mining system of FIG. 35.

FIG. 37 is a side view of the longwall mining system of FIG. 35.

FIG. 38 is a perspective view of a digging attachment.

FIG. 39 is another perspective view of the digging attachment of FIG. 38.

Before any embodiments are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for the purpose of description and should not be regarded as limiting. Unless specified or limited otherwise, the terms “mounted,” “connected,” “supported,” and “coupled” and variations thereof are used broadly and encompass both direct and indirect mountings, connections, supports, and couplings. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

### DETAILED DESCRIPTION

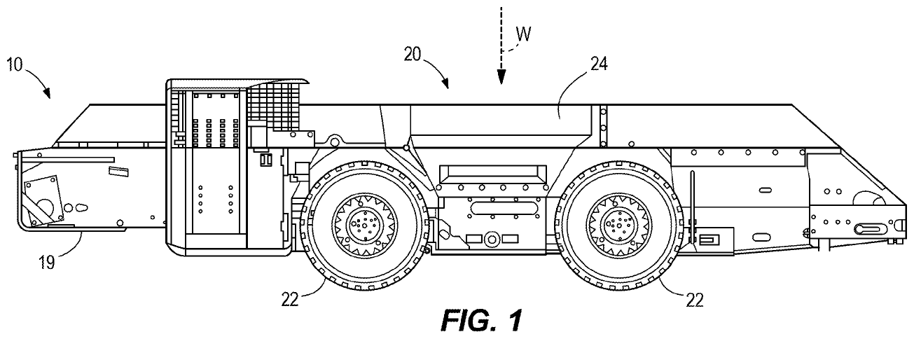

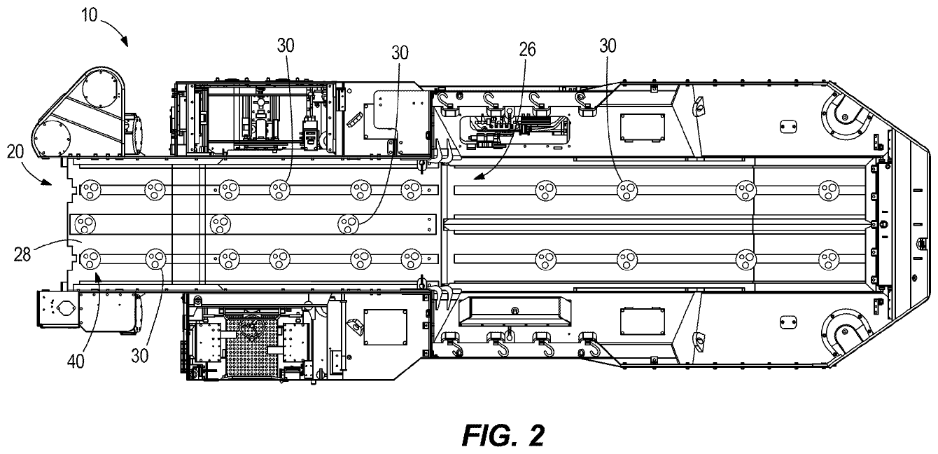

FIGS. 1 and 2 illustrate a mining machine 10 (for example, a haulage machine such as a shuttle car) operable to receive collected material. The shuttle car may receive cut material from another mining machine. While the disclosure refers to a shuttle car, it is understood that the disclosure can be incorporated into other types of machines such as, for example, a continuous mining machine for cutting material from a wall of a mine and including a conveyor for transporting cut material.

The shuttle car 10 is movable and operable to receive, transport, and transfer cut material. In the illustrated embodiment, the shuttle car 10 includes a chassis or frame 19, a receptacle or bed 20, and traction members (e.g., steerable wheels 22) coupled to the frame 19. In the illustrated embodiment, the bed 20 of the shuttle car 10 includes an open top 24 for receiving material and also includes a conveyor 26 for moving material along the length of the bed 20 (e.g., to discharge material from the bed 20). Over the operational life of the shuttle car 10, the bed 20 will experience wear. The wear may be caused by, among other things, material in the bed 20 rubbing and scraping against the surfaces of the bed structure. In one embodiment, the surfaces of the bed 20 may experience wear that causes the bed structure to deteriorate in the direction of arrow W. In the illustrated embodiments, one or more visual wear indicators 30 (FIG. 2) are positioned on the bed 20 to indicate the wear that the bed 20 has experienced.

As shown in FIG. 2, the visual wear indicators 30 are disposed on a wear deck 28 within the bed 20. The wear deck 28 is located proximate the conveyor 26 and provides a support surface for material on the bed 20. The illustrated embodiment includes twenty-three wear indicators 30 spaced about the wear deck 28. However, one of ordinary skill in the art will understand that the number and placement of wear indicators 30 can be different based on various considerations (e.g., type of machine, type and amount of wear that the machine experiences, etc.).

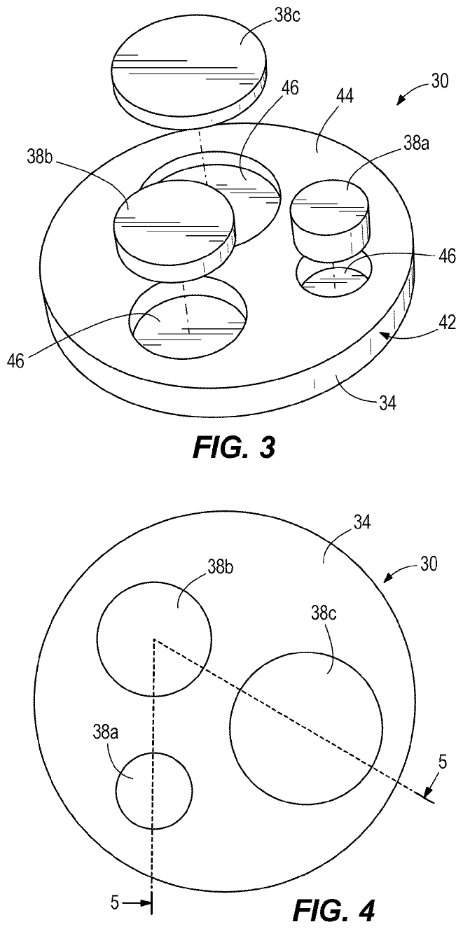

In the illustrated embodiment, each of the wear indicators 30 is configured to provide a visual indication of the material thickness of the wear deck 28, and thus of the remaining service life of the wear deck 28. Referring to FIG. 3, each wear indicator 30 includes an indicator housing 34 supporting material thickness indicators 38. In some embodiments, the wear indicator 30 may be positioned (e.g., embedded) in a surface of the wear deck 28 and a surface of the wear indicator 30 may be flush with the wear deck 28. As the material of the wear deck 28, and thus the wear indicators 30, is worn down, the material thickness indicators 38 are exposed. In the illustrated embodiment, each wear indicator 30 includes multiple material thickness indicators 38a, 38b, 38c to indicate various levels of wear. For example, the thickness indicators may be configured to visually indicate that the thickness has worn by 25% (38a), 50% (38b), and 75% (38c). However, it is understood that fewer or more indicators may be used and/or that the indicators may indicate different levels/percentages of wear (e.g., by modifying the number and size of the material thickness indicators 38 disposed within the indicator housing 34). For example, it may be desirable for a wear indicator 30 to include only one material thickness indicator 38 at 50% wear, or it may be desirable for a wear indicator 30 to include four material thickness indicators 38 at 20%, 40%, 60%, and 80% wear.

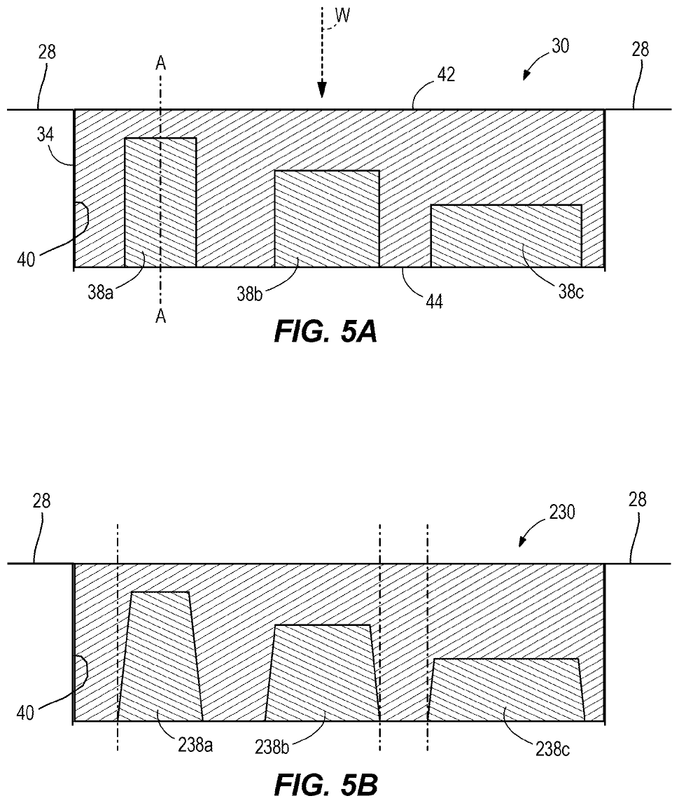

With reference to FIGS. 3-5, the indicator housing 34 may be sized and shaped to fit within an aperture 40 of the wear deck 28 (FIGS. 5A and 5B). When installed in the aperture 40, an upper surface 42 of the indicator housing 34 is flush with the wear deck 28, such that the indicator housing 34 and the wear deck 28 wear at approximately the same rate. Furthermore, the indicator housing 34 may be formed from the same material as the wear deck 28 so that it can be secured within the aperture 40 by welding. FIGS. 3-5 depict one embodiment of a wear indicator 30 including a puck shaped indicator housing 34 that is circular in profile when viewed along the wear direction W. In other embodiments, the indicator housing 34 may have other shapes. For example, an indicator housing 34 may have a rectangular profile. Moreover, the indicator housing 34 may be modified in other ways to facilitate assembly within the wear deck 28.

As shown in FIGS. 3 and 5, a bottom surface 44 of the indicator housing 34 includes a plurality of blind bores 46 positioned adjacent each other, and each bore 46 is sized and shaped to receive a respective one of the material thickness indicators 38. In some embodiments, the sizes of the blind bores 46 are intended to provide an interference fit between the indicator housing 34 and the material thickness indicators 38 to secure the material thickness indicators 38 within the indicator housing 34. The material thickness indicators 38 may be installed in the blind bores 46 using liquid nitrogen to accommodate for the interference fit. In other embodiments, the indicators 38 may be press fit and welded or brazed in place within the blind bores 46. The depth and width of the blind bores 46 correspond to the thickness and width of the material thickness indicator 38 that it receives. Thus, the depths of the blind bores 46 are less than a thickness of the indicator housing 34 such that the material thickness indicators 38 are covered by the upper surface 42 prior to experiencing wear.

In the illustrated embodiment of FIGS. 3-5, the three material thickness indicators 38a, 38b, and 38c are cylindrical or dowel-shaped. Each material thickness indicator 38a, 38b, 38c has a different thickness and cross-sectional area, as viewed along the wear direction W. Specifically, the first material thickness indicator 38a has a greater thickness than the second and the third material thickness indicators 38b, 38c. The thickness is measured along a longitudinal axis A (FIG. 5) of the indicator and may be substantially parallel to the wear direction W.

Furthermore, in the illustrated embodiment, the cross-sectional area of the first material thickness indicator 38a is less than those of the second and the third material thickness indicators 38b, 38c. Thus, the first material thickness indicator 38a is formed as a long and thin dowel when compared to the second and third material thickness indicators 38b, 38c. The second material thickness indicator 38b has a smaller thickness that the first material thickness indicator 38a and a greater thickness than the third material thickness indicator 38c. Similarly, the cross-sectional area of the second material thickness indicator 38b is larger than that of the first material thickness indicator 38a and smaller than that of the third material thickness indicator 38c. Finally, the third material thickness indicator 38c has the smallest thickness and the largest cross-sectional area when compared with the first and the second material thickness indicators 38a, 38b.

In the illustrated embodiment, the thickness of the first material thickness indicator 38a is sized such that it is first exposed when an upper surface 42 of the indicator housing 34 is worn down by 25% of a specified maximum permitted wear distance (for example, the specified maximum permitted wear distance may correspond to the overall thickness of the indicator housing 34). The thickness of the second material thickness indicator 38b is sized such that it is first exposed when the indicator housing 34 is worn down by 50%. At this point, both the first and the second material thickness indicators 38a, 38b are exposed. The thickness of the third material thickness indicator 38c is sized such that it is first exposed when the indicator housing 34 is worn down by 75%. At this point, all three material thickness indicators 38a, 38b, 38c are exposed.

The material thickness indicators 38 are formed from a different material than that of the indicator housing 34. In some cases, using a different material for the indicators 38 provides a contrast with the rest of the housing 34 and/or the deck 28 to more easily make a visual distinction between the indicator housing 34 and each of the material thickness indicators 38, thereby allowing an operator to identify which, if any, of the material thickness indicators 38 are exposed. For example, the material thickness indicators 38 may be formed of stainless steel 316 bar, high tensile brass bar (e.g., AS-1567-686 or BS2872-CW724R), wear resistant putty “Devcon” (e.g., ceramic epoxy WR2), forged dye colored ingot of 3 different colors, or other similar materials. As can be seen in Table 1 below, the material thickness indicators 38 of a wear indicator 30 may be formed of various combinations of the above-listed materials. Table 1 identifies examples of possible combinations and does not represent an exhaustive list.

TABLE 1
Example Material Combinations

| | |
|---|---|
| 1 | 38a - stainless steel |
| | 38b - stainless steel |
| | 38c - stainless steel |
| 2 | 38a - brass |
| | 38b - brass |
| | 38c - brass |
| 3 | 38a - putty |
| | 38b - putty |
| | 38c - putty |
| 4 | 38a - forged rod |
| | 38b - forged rod |
| | 38c - forged rod |
| 5 | 38a - stainless steel |
| | 38b - brass |
| | 38c - stainless steel |
| 6 | 38a - brass |
| | 38b - stainless steel |
| | 38c - brass |
| 7 | 38a - brass |
| | 38b - putty |
| | 38c - brass |
| 8 | 38a - putty |
| | 38b - brass |
| | 38c - putty |
| 9 | 38a - stainless steel |
| | 38b - putty |
| | 38c - stainless steel |
| 10 | 38a - putty |
| | 38b - brass |
| | 38c - stainless steel |
| 11 | 38a - putty |
| | 38b - stainless steel |
| | 38c - brass |
| 12 | 38a - stainless steel |
| | 38b - brass |
| | 38c - putty |

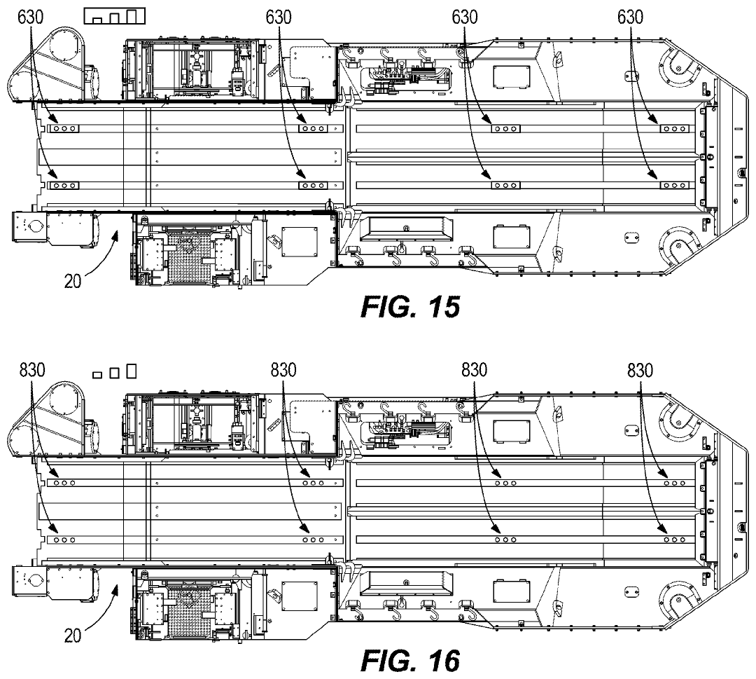

In some embodiments, the wear indicators 30 further include a plug (not shown) to secure each of the material thickness indicators 38 within its respective blind bore 46. The plug may be formed from the same material as the indicator housing 34 and secures the material thickness indicator 38 (e.g., by welding to the indicator housing 34 and capping the blind bore 46). Also, while the material thickness indicators 38 are illustrated in FIG. 5A as having a constant width (e.g., having a cylindrical or prismatic shape), in some embodiments (FIG. 5B) the material thickness indicators 238 may have a width that varies along the length of the indicator (e.g., tapered). Furthermore, in some embodiments (FIG. 14), the wear indicator 430 may omit a housing, and the thickness indicators 438 may be supported directly on the wear surface or within the wear surface. In still other embodiments (FIG. 15), the wear indicator 630 may have an elongated housing 640, and the thickness indicators 638 may be oriented in a linear configuration along a length of the housing 640. In still other embodiments (FIG. 16), the wear indicator 830 may include thickness indicators 838 oriented in a linear configuration and supported directly on the wear surface or within the wear surface.

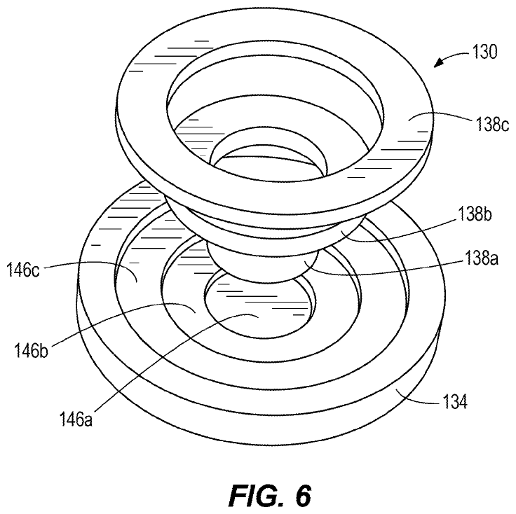

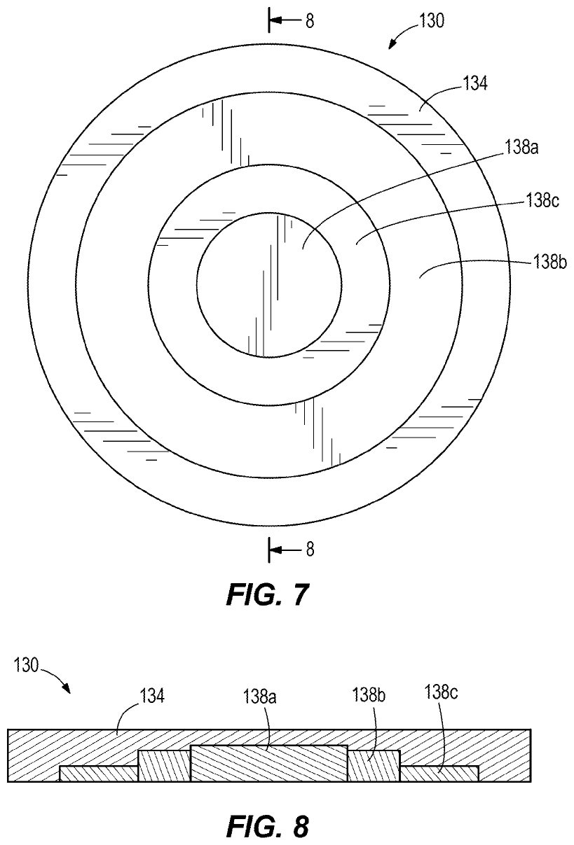

FIGS. 6-8 illustrate another embodiment of a wear indicator 130. Aspects of the wear indicator 130 that are similar to the wear indicator 30 are identified with similar reference numbers, plus 100. Some differences between the wear indicator 30 and the wear indicator 130 are described herein.

The wear indicator 130 includes material thickness indicators 138 provided as concentric annular rings about a center indicator. The first material thickness indicator 138a is disposed at the center of the indicator housing 134. The second annular material thickness indicator 138b circumscribes the first material thickness indicator 138a, and the third annular material thickness indicator 138c circumscribes the second annular material thickness indicator 138b. In some embodiments, the first and third material thickness indicators 138a, 138c are formed from the same material, while the second annular material thickness indicator 138b is formed from a different material. In some embodiments, the first and third material thickness indicators 138a, 138c are formed from brass, and the second annular material thickness indicator 138b is formed from steel. The use of different materials provides a visual contrast that assists an operator in identifying which, if any, of the first, the second, or the third annular material thickness indicators 138 are exposed. For example, Table 1, above, lists various combinations of materials that are applicable to the wear indicator 130 as well as the wear indicator 30.

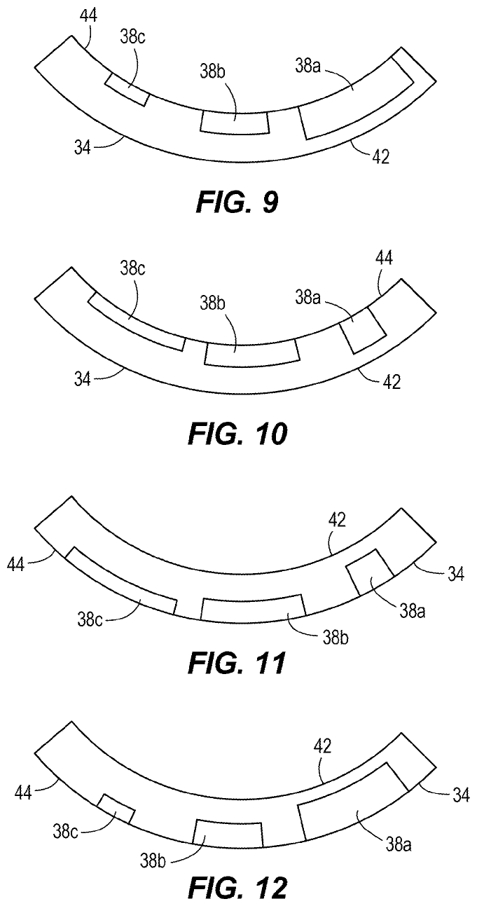

As shown in FIG. 9, the indicator housing 34 can take various shapes/profiles (e.g., depending on a shape/profile of the wear deck 28). Specifically, FIG. 9 depicts a wear indicator 30 having a curve or radius positioned on the upper surface 42 of the indicator housing 34. This allows the wear indicator 30 to be applied to a curved wear deck 28 without interrupting the surface of the wear deck 28. In other words, the upper surface 42 of the wear indicator 30 is shaped to correspond to the wear deck 28 such that the upper surface 42 and the wear deck 28 are flush, even if the wear deck 28 is not flat. As shown in FIGS. 9-12, the thickness indicators 38a, 38b, 38c can be positioned adjacent either a concave or a convex surface.

The above wear indicators 30, 130 have been described in connection with the wear deck 28 of a shuttle car 10. However, the wear indicators 30, 130 may be applied to other types of machines and components that experience wear. The wear indicators 30, 130 are intended to be secured within a surface that experiences wear during operation. Specifically, the wear indicators 30, 130 may be positioned to provide an indication of thickness at key locations on the surface being worn.

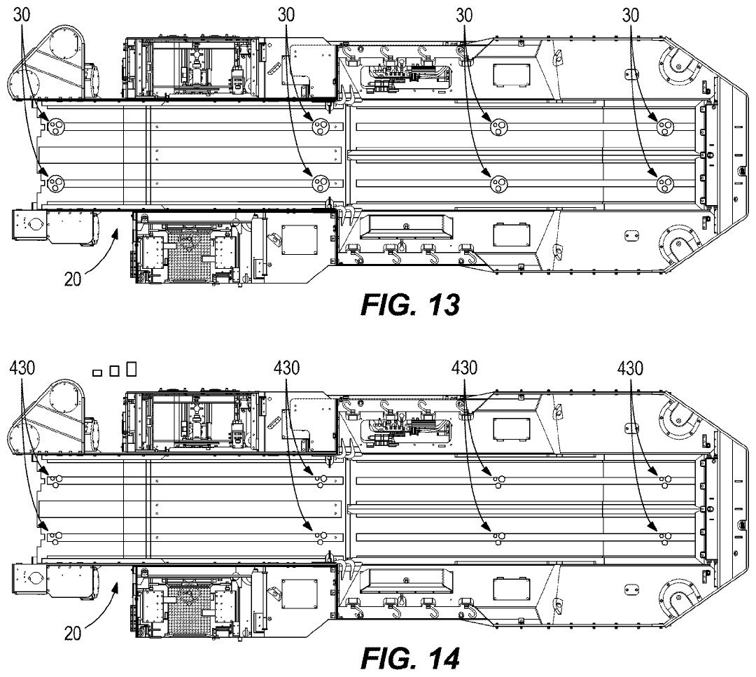

As shown in FIG. 13, the wear indicators 30 may be positioned on the bed 20 of the mining machine in a different configuration. For example, the bed 20 may include a pair of wear indicators 30 (e.g., a right wear indicator and a left wear indicator) positioned at four distances along a length of the bed 20. In other embodiments (FIGS. 14-16), wear indicators 430, 630, 830 may be positioned on the bed 20 in a similar manner.

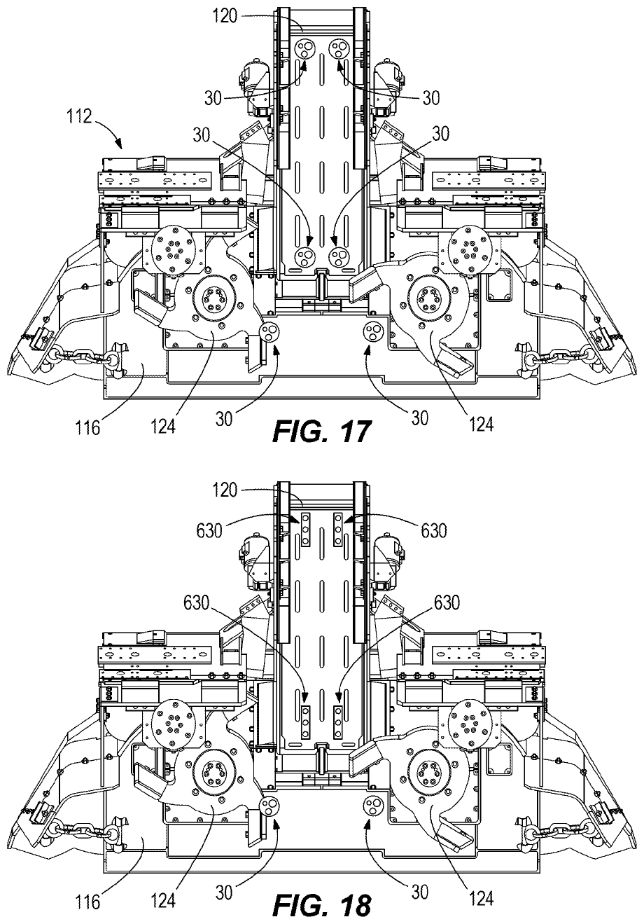

The wear indicators 30, 230, 430, 630, 830 may be incorporated into other mining machines and components, and may be incorporated into machines and components that may operate together and have adjacent, connected, and/or complementary operations. For example, as shown in FIG. 17, a shovel or material handling device 112 for an entry development machine or continuous mining machine includes a deck 116 and a conveyor 120 positioned adjacent a rear end of the deck 116. The conveyor 120 may extend along a conveyor axis, and is aligned with an opening of the deck 116. The material handling device 112 further includes arms 124 for directing material on the deck 116 toward the opening and onto the conveyor 120. In the illustrated embodiment, the material handling device 112 includes a pair of wear indicators 30 adjacent the opening (e.g., one wear indicator 30 adjacent a left side of the opening and one wear indicator 30 adjacent a right side of the opening). In addition, wear indicators 30 may be positioned at intervals along the length of the conveyor 120 (e.g., a right wear indicator and a left wear indicator positioned proximate the deck 116, and a right wear indicator and a left wear indicator positioned proximate an end of the conveyor 120 opposite the deck 116).

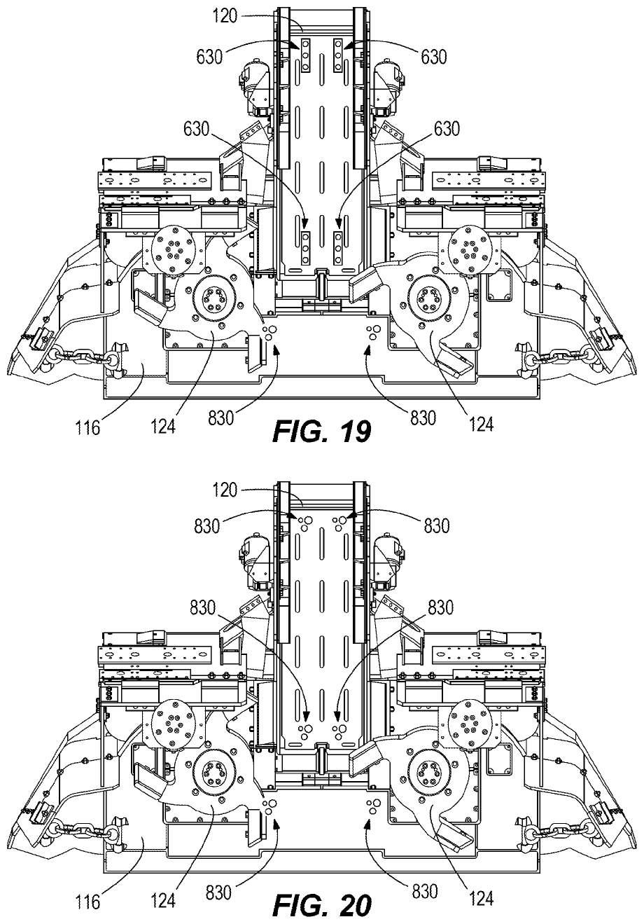

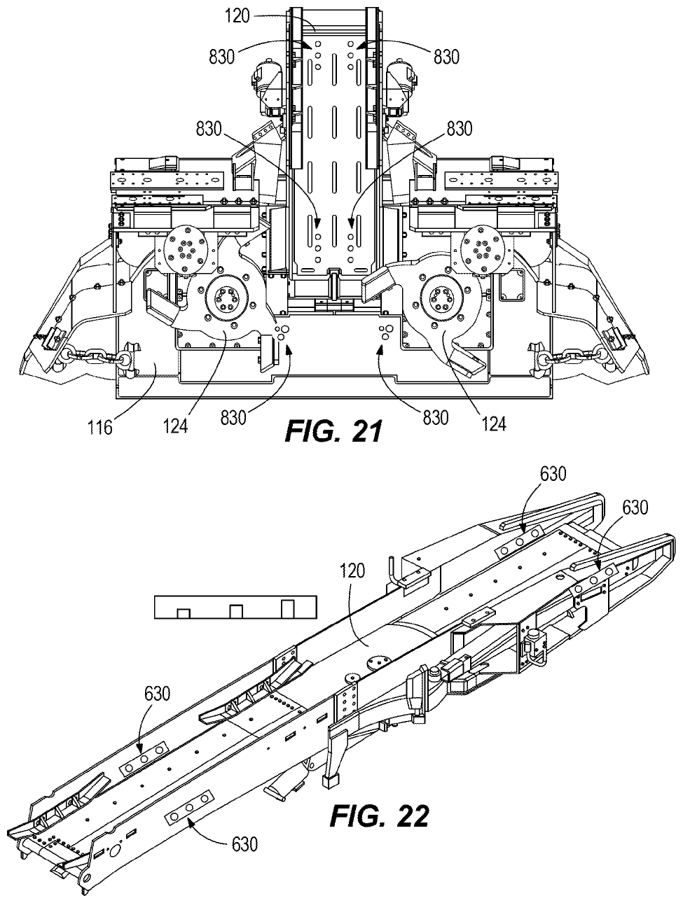

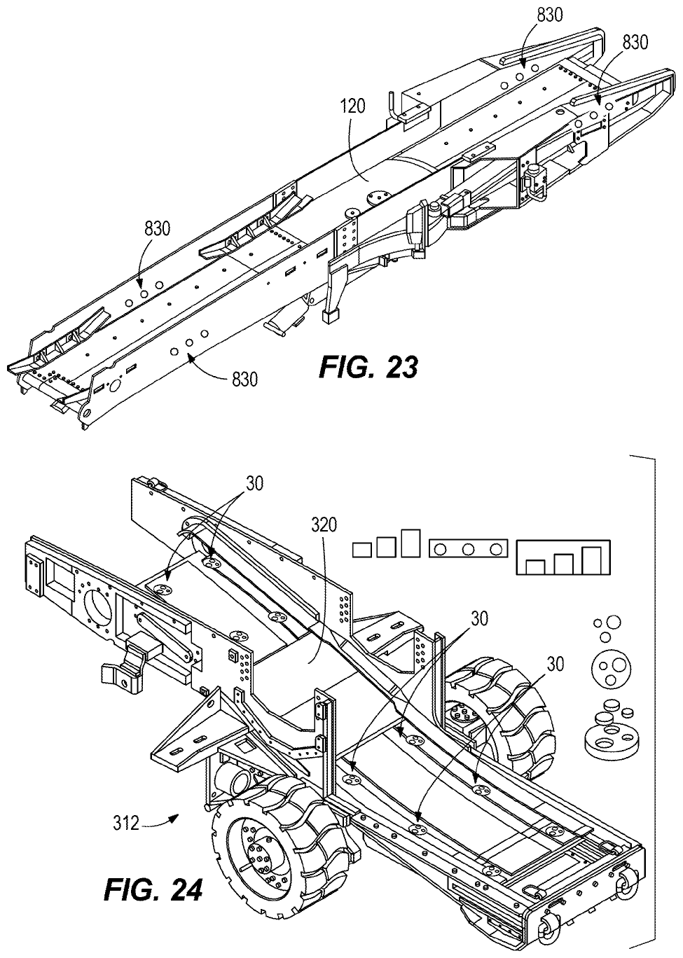

Multiple embodiments of the wear indicators 30, 230, 430, 630, 830 may be incorporated into the mining machine. For example, as shown in FIG. 18, the wear indicators 30 may be positioned on the deck 116, while wear indicators 630 may be positioned on the conveyor 120. In other embodiments, as shown in FIG. 19, wear indicators 430 may be positioned on the deck 116, while wear indicators 630 may be positioned on the conveyor 120. In still other embodiments, as shown in FIG. 20, wear indicators 430 may be positioned on the deck 116 and the conveyor 120. In still other embodiments, as shown in FIG. 21, wear indicators 430 may be positioned on the deck 116 and wear indicators 830 may be positioned on the conveyor 120. Wear indicators may also be positioned on side walls of the conveyor 120. For example, wear indicators 630 (FIG. 22) and/or wear indicators 830 (FIG. 23) may be positioned on the side walls.

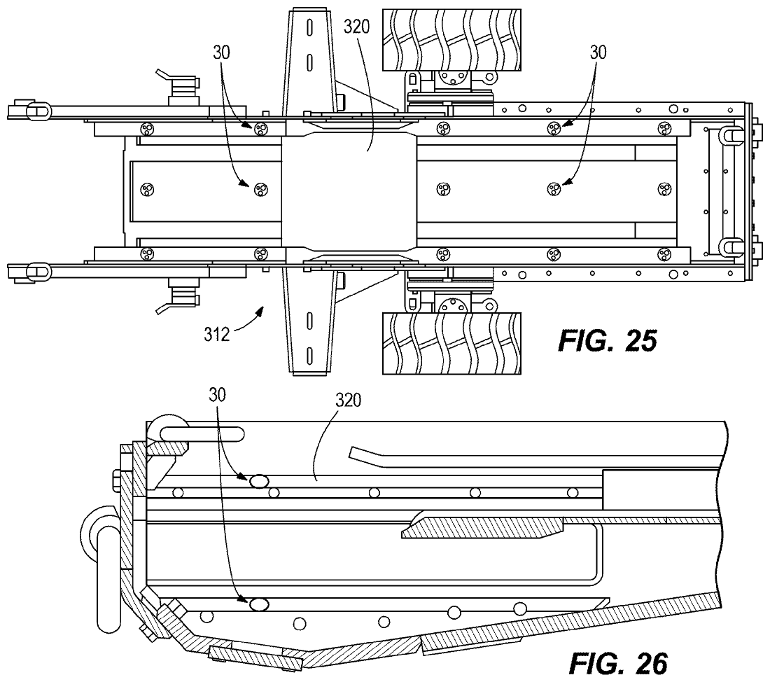

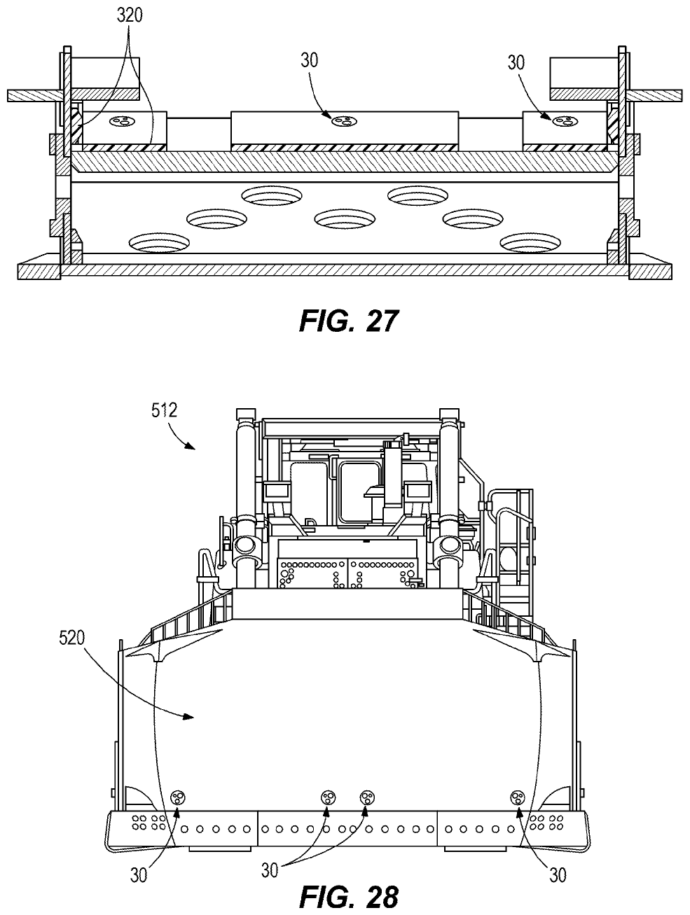

As shown in FIGS. 24-27, wear indicators 30, 230, 430, 630, 830 may be incorporated into other components, such as a lumpbreaker frame 312 (e.g., for a flexible conveyor train). As shown in FIG. 24, the lumpbreaker frame 312 includes a deck 320 along which material is conveyed, and wear indicators 30, 230, 430, 630, 830 may be positioned at regular intervals along a length of the deck 320. For example, the wear indicators 30, 230, 430, 630, 830 may include a right wear indicator, a left wear indicator, and a central wear indicator, positioned at five locations along a length of the deck 320. Also, at least some of the wear indicators 30, 230, 430, 630, 830 may be positioned on a lower surface of the deck 320 (FIG. 26).

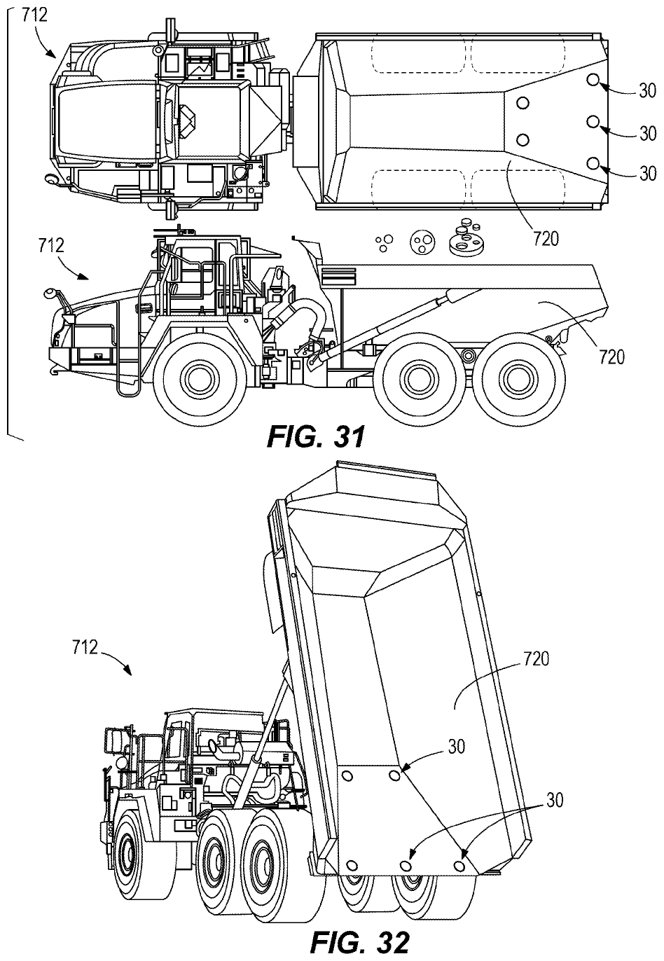

As shown in FIGS. 28-30, wear indicators 30, 230, 430, 630, 830 may be incorporated into other types of machines, such as a dozer 512. As shown in FIGS. 31 and 32, the truck includes a blade 520 for pushing material, and wear indicators 30, 230, 430, 630, 830 may be positioned at intervals along a lower portion of the blade 520. For example, the wear indicators 30, 230, 430, 630, 830 may include one or more right wear indicators 30a, one or more left wear indicators 30b, and one or more central wear indicators 30c. In addition, one or more wear indicators 30 may be positioned on support members 524 (FIG. 30), and/or one or more wear indicators 30 may be positioned on an outer side surface of the blade 312.

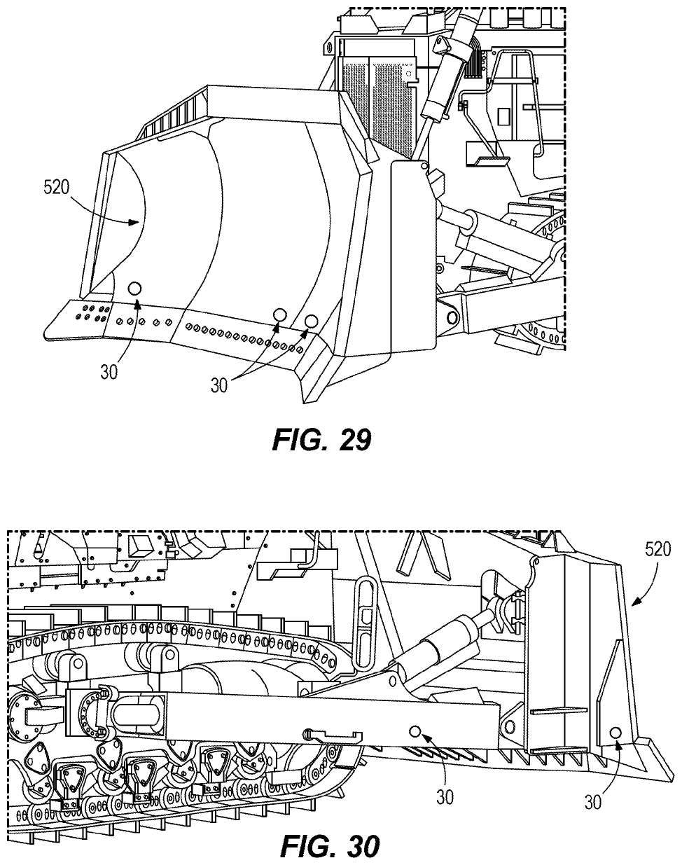

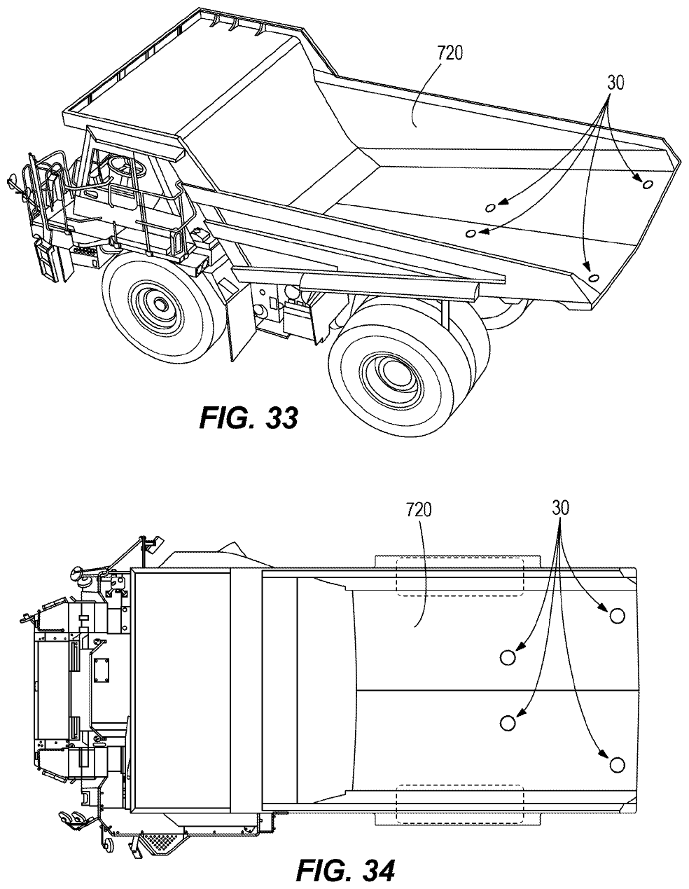

As shown in FIGS. 31 and 32, wear indicators 30, 230, 430, 630, 830 may be incorporated into other types of machines, such as a haul truck 712 (e.g., an articulated truck). As shown in FIGS. 22 and 29, the truck 712 includes a bed 720 for carrying material, and wear indicators 30, 230, 430, 630, 830 may be positioned at intervals along a portion of the bed 720. For example, the wear indicators 30, 230, 430, 630, 830 may be positioned in a trapezoidal pattern as shown in FIGS. 31 and 32 along an inclined surface of the bed 720. The wear indicators may include a left forward wear indicator, a right forward wear indicator, a left rear wear indicator, a right rear wear indicator, and a central rear wear indicator. The left and right rear wear indicators may be spaced apart from one another by a distance that is greater than a distance between the right and left forward wear indicators. In other embodiments (FIGS. 33 and 34), the wear indicators 30, 230, 430, 630, 830 may be positioned on a bed 720 of another type of truck.

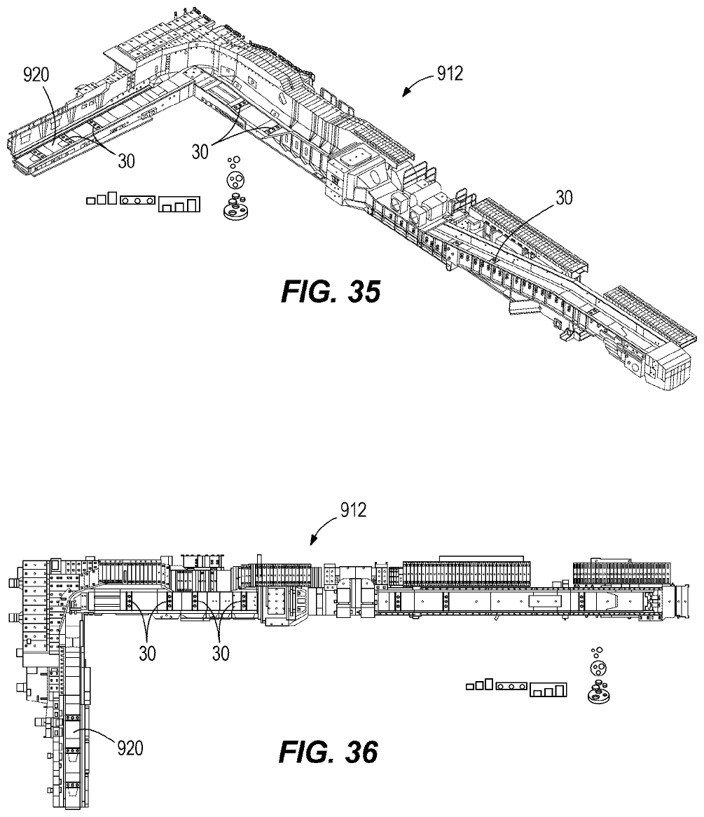

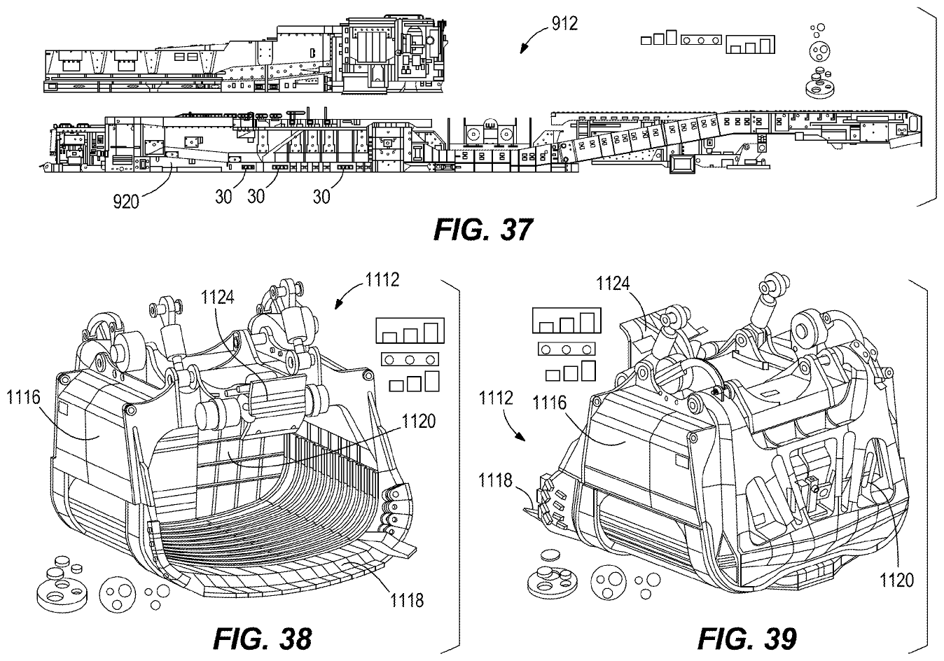

As shown in FIGS. 35-37 wear indicators 30, 230, 430, 630, 830 may be incorporated into other types of machines, such as a longwall conveyor. As shown in FIGS. 35-37, the conveyor 912 may include multiple interconnected pans 920, and chain flights (not shown) push material along a surface of the pans 920. Wear indicators 30, 230, 430, 630, 830 may be positioned at intervals along a length of the conveyor 920 (e.g., at predetermined distances between pans 920. While FIGS. 35-37 illustrate positions of wear indicators 30, it should be understood that wear indicators 230, 430, 630, or 830 may be positioned at the same or similar locations in place of or in combination with the wear indicators 30.

As shown in FIGS. 38 and 39, wear indicators 30, 230, 430, 630, 830 may be incorporated into other types of machines, such as a digging attachment 1112 (e.g., a dipper for a rope shovel). As shown in FIGS. 38 and 39, the digging attachment 1112 may include a dipper body 1116 having a digging edge 1118, a dipper door 1120 pivotably coupled to the dipper door 1120, and a bail 1124 for securing an end of a hoist rope (not shown) relative to the dipper body 1116. Wear indicators 30, 230, 430, 630, 830 may be positioned at locations on the inner surfaces of the dipper body 1116 (e.g., side surfaces, lower surfaces), on portions of the digging edge 1118, and/or on the bail 1124. Wear indicators 30, 230, 430, 630, 830 may be positioned on a portion of the dipper door 1120 (FIG. 39).

Although aspects of the disclosure have been described in detail with reference to certain embodiments, variations and modifications exist within the scope and spirit of one or more independent aspects as described.

Various features and advantages of the disclosure are set forth in the following claims.

1. A wear indicator supported on a wear surface of a machine component, the wear indicator comprising:
a first material thickness indicator having a first thickness;
a second material thickness indicator positioned adjacent the first material thickness indicator and having a second thickness that is less than the first thickness; and
a third material thickness indicator positioned adjacent the first material thickness indicator and the second material thickness indicator and having a third thickness that is less than the second thickness,
wherein the wear indicator is configured to visually indicate a material thickness of the wear surface via the first, second, and third material thickness indicators.

2. The wear indicator of claim 1, wherein the first material thickness indicator is disposed within an indicator housing, the second material thickness indicator is disposed within the indicator housing, and the third material thickness indicator is disposed within the indicator housing.

3. The wear indicator of claim 2, wherein the indicator housing includes an upper surface configured to be positioned flush with the wear surface, and wherein, prior to experiencing wear, the first material thickness indicator is covered by the upper surface.

4. The wear indicator of claim 3, wherein the indicator housing includes a bottom surface opposite the upper surface, the bottom surface including a plurality of blind bores configured to receive the first, second, and third material thickness indicators therein.

5. The wear indicator of claim 1, wherein the first, second, and third material thickness indicators are positioned such that the first thickness, the second thickness, and the third thickness are measured parallel to a direction of wear of the wear surface.

6. The wear indicator of claim 1, wherein the first thickness corresponds to 75% of a thickness of the wear indicator, such that the first material thickness indicator is configured to visually indicate 25% wear of the wear surface.

7. The wear indicator of claim 6, wherein the second thickness corresponds to 50% of the thickness of the wear indicator, such that the second material thickness indicator is configured to visually indicate 50% wear of the wear surface.

8. The wear indicator of claim 7, wherein the third thickness corresponds to 25% of the thickness of the wear indicator, such that the third material thickness indicator is configured to visually indicate 75% wear of the wear surface.

9. The wear indicator of claim 1, wherein the first, second, and third material thickness indicators are formed from a material with a different color than that of the wear surface.

10. The wear indicator of claim 1, wherein the first material thickness indicator has a first cross-sectional area as viewed along a wear direction, the second material thickness indicator has a second cross-sectional area as viewed along the wear direction, and the third material thickness indicator has a third cross-sectional area as viewed along the wear direction, and wherein the first cross-sectional area is less than the second cross-sectional area and the third cross-sectional area.

11. The wear indicator of claim 10, wherein the second cross-sectional area is less than the third cross-sectional area.

12. The wear indicator of claim 11, wherein the first, second, and third material thickness indicators are cylindrical.

13. The wear indicator of claim 2, wherein the indicator housing is circular in profile when viewed parallel to a wear direction of the wear indicator.

14. The wear indicator of claim 2, wherein the indicator housing includes an upper surface configured to be positioned flush with the wear surface, and wherein the upper surface and the wear surface are curved.

15. A mining machine comprising:
a chassis;
a wear deck supported by the chassis, the wear deck configured to support a material being mined;
a mechanism for moving the material across the wear deck; and
a plurality of wear indicators supported adjacent a surface of the wear deck, the plurality of wear indicators configured to provide a visual indication of a thickness of the wear deck.

16. The mining machine of claim 15, wherein each of the plurality of wear indicators includes a plurality of material thickness indicators configured to visually indicate 25%, 50%, and 75% wear.

17. The mining machine of claim 15, wherein the plurality of material thickness indicators are formed of a material having a different color than a material of the wear deck.

18. The mining machine of claim 15, wherein each of the plurality of material thickness indicators is disposed within an indicator housing, and wherein the indicator housing and the wear deck are formed of the same material.

19. The mining machine of claim 15, wherein an upper surface of the indicator housing is configured to be flush with the surface of the wear deck such that the indicator housing and the wear deck wear at the same rate.

20. The mining machine of claim 15, wherein the wear indicators are disposed on the wear deck.

21. The mining machine of claim 15, wherein the wear indicators are disposed under the surface of the wear deck.

22-31. (canceled)

32. A wear indicator system supported on a machine component, the wear indicator system comprising:
a plurality of wear indicators positioned within proximity to each other on a machine component, the wear indicators secured within bores of the machine component formed on a surface opposite a wear surface of the machine component, the plurality of wear indicators including,
a first wear indicator being spaced apart from the wear surface by a first distance, visible exposure of the first wear indicator indicating that the wear surface has completed a first stage of wear,
a second wear indicator being spaced apart from the wear surface by a second distance greater than the first distance, visible exposure of the second wear indicator indicating that the wear surface has completed a second stage of wear, and
a third wear indicator being spaced apart from the wear surface by a third distance greater than the second distance, visible exposure of the third wear indicator indicating that the wear surface has completed a third stage of wear.

33. The wear indicator system of claim 32, wherein the first wear indicator, the second wear indicator, and the third wear indicator are spaced apart from one another by between approximately 0 cm and approximately 5 cm.

34. The wear indicator system of claim 32, wherein the wear indicators are grouped within an indication area having a width of approximately 20 cm.

35. The wear indicator system of claim 32, wherein the bores include a plurality of blind holes, wherein each of the wear indicators is positioned within an associated one of a plurality of blind holes, each blind hole having a different depth that corresponds to a height of the respective wear indicator positioned within the blind hole.

36-38. (canceled)

39. The wear indicator system of claim 32, wherein the wear indicators are secured to the component via an interference fit.

40. The wear indicator system of claim 32, wherein the wear indicators are secured to the component via an adhesive.

41. The wear indicator system of claim 32, wherein each of the wear indicators has the same cross-sectional dimension as the others.

42. The wear indicator system of claim 32, wherein the system further comprises a plurality of groups of wear indicators, each group positioned the machine component as different locations and configured to detect wear at different locations on the machine component.

43. The wear indicator system of claim 42, wherein visible exposure of one indicator of one of the groups indicates 25% wear at that location, visible exposure of two indicators of the one group indicates 50% wear at that location, and visible exposure of three indicators of the one group indicates 75% wear at that location.
